(19) United States
(12) Patent Application Publication
(10) Pub. No.: US 2023/0250599 A1
(43) Pub. Date: Aug. 10, 2023

(54) Barrier body arrangement for a passage barrier of an access control system

(71) Applicant: Scheidt & Bachmann GmbH, Mönchengladbach (DE)

(72) Inventor: Andreas Krätzig, Mönchengladbach (DE)

(21) Appl. No.: 18/164,761

(22) Filed: Feb. 6, 2023

(30) Foreign Application Priority Data
Feb. 9, 2022 (DE) 10 2022 103 045.8

(51) Int. Cl. E01F 13/04; E01F 9/615

(52) U.S. Cl. CPC E01F 13/04; E01F 9/617

(57) ABSTRACT

A barrier body arrangement for a passage barrier of an access control system, includes at least a first substantially optically transparent barrier body having a first light coupling surface, at least one second substantially optically transparent barrier body having at least one second light coupling surface, wherein the first barrier body is connected to the second barrier body, at least one light source device configured to couple light into the first light coupling surface and/or the second light coupling surface, and at least one substantially optical transparent separation layer arranged between the first barrier body and the second barrier body.

### CROSS-REFERENCE TO RELATED APPLICATIONS

This application claims the benefit of German patent application No. 10 2022 103 045.8 filed Feb. 9, 2022, the disclosures of which are incorporated herein by reference in their entirety.

### TECHNICAL FIELD

The application relates to a barrier body arrangement for a passage barrier of an access control system. Furthermore, the application relates to a passage barrier of an access control system and a method for operating a passage barrier.

### BACKGROUND ART

Access control systems respectively entry control systems for controlling access from a first area to a second area are known from the prior art. For example, access (respectively entry) from an uncontrolled area to a controlled area and/or access (respectively exit) from a controlled area to an uncontrolled area may be controlled using an access control system.

Access control systems according to the present application thus serve to control an entering respectively going into a controlled area by a user or a leaving respectively exiting a controlled area by a user. In particular, an access control system according to the present application is not an access system in which a driving into a controlled area by a vehicle or a driving-out from a controlled area by a vehicle is controlled.

An access control system typically comprises at least one passage barrier (also referred to as a gate). A passage barrier is configured to selectively block and selectively release an entrance (i.e., in particular allowing entering) from a first area to a second area. A passage barrier can in particular ensure that only authorized users can pass through respectively go through an entrance and/or exit of a controlled area, for example, in order to enter the controlled area and/or to leave the controlled area.

Access control systems are used, for example, in people transport systems, but also in other applications in which an authorization of users is to be controlled, such as at sports, cultural and/or leisure events. Access control systems may also be configured to verify a user's authorization to be in a controlled area. The verification result may be indicated, for example, by a display of a passage barrier.

Known passage barriers are configured to check a user's access authorization before releasing a passing of the passage barrier. For example, access control systems are known in which an access medium of a user is checked before a release. For controlling respectively checking the authorization of the user for staying in a controlled area, a passage barrier may comprise at least one interface equipment. The interface equipment is configured to receive an access authorization of the user, which is stored, for example, in the access medium or to receive a user identification which is linked to an access authorization stored on the system side, or which represents a payment means with which the use of the controlled area can be paid.

Thus, the user may have an access medium, preferably a ticket medium, with an access code, in particular a ticket code (e.g., magnetic stripe code, graphical ticket code, such as a barcode or QR code, RFID identifier, other readable user or mobile device identifier, etc.), that can be read by the interface equipment of the passage barrier. The access code may contain as data content at least the user's access authorization or an identification respectively identifier of the user that can be used to verify and/or pay for the user's access authorization.

A passage barrier generally comprises at least one base and at least one barrier body arrangement movably arranged at the base. It is in particular known from the prior art that the barrier body arrangement can be formed by a plate-shaped respectively disk-shaped barrier body. This barrier body can be moved, for example by an actuator (e.g. an electric motor) integrated in the base. In particular, the barrier body can be moved between an open position and a closed position. In the open position, in particular, the passage through the passage barrier is enabled, thus a user can pass through the passage barrier. In the closed position, in particular, the passage is blocked, i.e. a user is (physically) prevented from passing through the passage barrier.

In an initial state, a passage barrier is usually blocked. As has already been described, this means that the barrier body arrangement physically prevents the user from passing through the passage barrier. In other cases, a passage barrier may be open in its initial state and close only when a user without a valid access authorization respectively ticket code attempts to pass through the passage barrier. Without limiting generality, it is hereinafter assumed that a passage barrier is blocked in the initial state and opens upon a positive verification of a user's access authorization for the user to go through.

Regularly, a passage barrier is only operated in one passage direction, i.e. in a specific passage direction state. This means that users can only (properly) pass through a passage barrier in one direction. For example, in this operating state, the passage barrier may only allow entry into the controlled area or only allow exit from the controlled area.

However, the passage direction of a passage barrier respectively the passage direction state may be changed during operation to provide, for example, a passing of the passage barrier in a first passage direction during a first time period and a passing of the passage barrier in the opposite passage direction during another time period.

However, it is often problematic for users to recognize in which direction a passage barrier is (currently) operated. It is known from the prior art to indicate on a (small) screen respectively display of the passage barrier whether passing the passage barrier in the desired passage direction of a user at the passage barrier is possible or not.

However, this displaying is often only sufficiently visible to the user directly in front of the passage barrier. In addition, defective passage barriers or barriers that are currently not ready for use for other reasons are often only visible to the user when the user is directly at the passage barrier. On the one hand, this leads to reduced user comfort. On the other hand, this reduces the throughput through the at least one passage barrier, in particular through a series of passage barriers arranged next to each other (also referred to as a “gate array”), which can be operated variably in different passage directions, for example, in the manner described.

Therefore, the object of the present application is to provide a possibility which improves user comfort at a passage barrier and, in particular, enables an increase in throughput at the passage barrier respectively at a series of several passage barriers (“gate array”).

### SUMMARY OF THE INVENTION

This object is solved according to a first aspect of the application by a barrier body arrangement for a passage barrier of an access control system. The barrier body arrangement comprises at least one first substantially optically transparent barrier body having at least one first light coupling surface. The barrier body arrangement comprises at least one second substantially optically transparent barrier body having at least one second light coupling surface. The first barrier body is connected to the second barrier body. The barrier body arrangement comprises at least one light source device. The light source device is configured to couple light into the first light coupling surface and/or the second light coupling surface. At least one substantially optically transparent separation layer is arranged between the first barrier body and the second barrier body.

By providing, in contrast to the prior art, a barrier body arrangement for a passage barrier of an access control system comprising a substantially transparent barrier body composite having at least two connected barrier bodies and a substantially transparent separation layer positioned therebetween, and at least one light source device for coupling light into the barrier body composite, the user comfort at a passage barrier is improved and, in particular, an increase in throughput at the passage barrier is enabled. In particular, the throughput at an inlet and/or outlet of the access control system is improved.

Thus, the barrier body arrangement according to the application has a large and widely visible surface which can be used according to the application, for example, to indicate to users the current direction of passage. In particular, the barrier body arrangement according to the application enables a different (for example two-colored) illumination of the at least two substantially transparent barrier bodies. This makes it possible, for example, to display different information (e.g., different color) on respectively at the front side of the barrier body arrangement than on respectively at the rear side of the barrier body arrangement.

A barrier body arrangement according to the application serves as a blocking element of a passage barrier. A passage barrier comprises in particular at least one base and at least one barrier body arrangement movably arranged on the base.

According to the application, the barrier body arrangement comprises in particular an essentially optically transparent composite body. The composite body is formed in particular from at least two interconnected barrier bodies, with a separation layer being arranged between the barrier bodies. The at least two barrier bodies and the separation layer are substantially optically transparent. In the present case, essentially optically transparent means in particular that the predominant part of the visible electromagnetic radiation is transmitted by such a barrier body respectively such a separation layer. An essentially optically transparent barrier body respectively an essentially optically transparent separation layer means in particular a barrier body respectively a separation layer with a light transmittance of at least greater than 70%, preferably greater than 75%.

The optically transparent separation layer may, for example, be formed of air. The separation layer according to the application can preferably be an optically transparent separating film, particularly preferably a polymeric separating film, such as a PVC (polyvinyl chloride) separating film.

According to an embodiment of the barrier body arrangement, the separating film may be a (double-sided) self-adhesive separating film.

In particular, the separation layer can be configured to (mechanically) join respectively connect the at least two barrier bodies to one another and, in particular, for simultaneously optically separating the barrier bodies from one another.

The separation layer can preferably have a thickness of between 0.05 mm and 10 mm, particularly preferably between 0.15 mm and 0.5 mm.

According to a preferred embodiment, a (first and/or second) barrier body may be formed of a substantially transparent plastic. Preferably, a (first and/or second) barrier body may be formed of acrylic glass and/or polymer carbonate.

According to the application, the first barrier body and the second barrier body each have at least one light coupling surface. A light coupling surface is in particular the (outer) surface area of a barrier body at which light is coupled-in respectively introduced by a light source device of the barrier body arrangement. The coupled-in light can propagate in the respective barrier body. In other words, a barrier body is configured in particular as a light guide in the present case. In particular, a first light source device may be connected to the light coupling surface of the first barrier body, and a second light source device may be connected to the light coupling surface of the second barrier body, wherein both barrier bodies with the intermediate separation layer constitute the barrier body arrangement according to the application.

The at least one light source device of the barrier body arrangement may comprise at least one light source. The at least one light source device may be configured to generate light respectively visible electromagnetic radiation. Preferably, the light source device may comprise a plurality of light sources. In particular, the at least one light source may be a light emitting diode (LED). It shall be understood that other light sources (e.g., gas discharge lamp, laser, etc.) may be used in other variants of the application.

The at least one light source device is arranged in particular on an outer side of the barrier body composite respectively of the first barrier body and of the second barrier body in such a way that light generated by the light source device is coupled into the respective barrier bodies at the first light coupling surface and in particular additionally at the second light coupling surface.

In order to prevent light coupled into the first barrier body from propagating into the second barrier body (or light coupled into the second barrier body from propagating into the first barrier body), the substantially transparent (optical) separation layer is arranged between said barrier bodies according to the application.

According to a preferred embodiment of the barrier body arrangement according to the application, the (optical) separation layer can be characterized by the fact that the separation layer refractive index of the separation layer can be at least smaller than a first barrier body refractive index of the first barrier body and a second barrier body refractive index of the second barrier body. In this way, it can be achieved that the respective coupled light propagates in the respective barrier body and, in particular, cannot diffuse into the respective other barrier body.

According to a further embodiment of the barrier body arrangement according to the application, the separation layer refractive index may be at least less than 1.5. Preferably, the separation layer refractive index may be between 1 and 1.49. In particular, in addition, the at least one (first or second) barrier body refractive index may be greater than or equal to 1.5. Preferably, the at least one (first or second) barrier body refractive index may be between 1.5 and 1.9. In particular, said values refer to normal conditions at a wavelength of 589 nm (yellow-orange) of the sodium D-line.

According to a further embodiment of the barrier body arrangement according to the application, the light source device may comprise an optically non-transparent encapsulation. This means, in particular, that the at least one light source of the light source device is surrounded by a light-tight encapsulation respectively a light-tight housing. The encapsulation is preferably arranged such that the light generated by the light source device, in particular the at least one light source, is coupled only into the first light input coupling surface and/or the second light input coupling surface. In other words, the at least one light source is preferably completely surrounded by the encapsulation and the first barrier body and/or the second barrier body (respectively the respective outer wall of the barrier bodies).

In particular, the encapsulation can be formed from metal. For example, the encapsulation can be formed from a metal sheet. It shall be understood that in other variants other light-tight materials may also be used.

Preferably, the encapsulation respectively the housing can have a U cross-sectional shape. The light coupling surface of the first barrier body and/or of the second barrier body can be arranged on the open side of the U cross-sectional shape, i.e. in particular an outer side of the first barrier body and/or second barrier body. In other words, the open side of the U-shaped cross-section can be (completely) closed by the first and/or second light coupling surface.

By preferably completely encapsulating the at least one light source of the light source device, extraneous light can be prevented from being coupled in.

According to a further preferred embodiment of the barrier body arrangement according to the application, the light source device may comprise at least one first light source. The at least one first light source may be configured to generate light in a first light wavelength range. The light source device may comprise at least one second light source. The at least one second light source may be configured to generate light in a second light wavelength range, in particular different from the first light wavelength range. In particular, a plurality of first light sources and a plurality of second light sources may be arranged in the light source device. Thereby, a two-color illumination of the barrier body arrangement can be provided in a simple manner.

As has already been described, the at least one first light source may preferably be an LED and/or the at least one second light source may preferably be an LED.

Exemplary light wavelength ranges that can be generated by the first light source or the second light source comprise, in particular, 610 nm to 760 nm (red light), 590 nm to 610 nm (orange light), 570 nm to 590 nm (yellow light), 500 nm to 570 nm (green light), 450 nm to 500 nm (blue light), and 400 nm to 450 nm (violet light). For example, the at least one first light source may be an LED (e.g., gallium arsenide phosphide (GaAsP) or aluminum gallium indium phosphide (AlGaInP) LED) configured to generate red light, and the at least one second light source may be an LED (e.g., an indium gallium nitride (InGaN) or gallium nitride (GaN) LED) configured to generate green light. With these colors, for example, it can be signaled in a clear manner to a user whether a passage barrier is immediately passable from the user's point of view (preferably signaled by the color green) or not passable (preferably signaled by the color red).

According to a particularly preferred embodiment of a barrier body arrangement according to the application, the at least one first light source may be arranged in the light source device such that the generated light is coupled only into the at least one first light coupling surface. In other words, the at least one first light source couples the light generated by it only into the first barrier body. The at least one second light source may be arranged in the light source device such that the generated light is coupled only into the at least one second light coupling surface. In other words, the at least one second light source couples the light generated by it only into the second barrier body. According to the above example, for example, red light may be coupled only into the first barrier body and green light may be coupled only into the second barrier body.

As has already been described, the light source device may preferably comprise an encapsulation. Preferably, an optically non-transparent source separation layer may be arranged between the at least one first light source and the at least one second light source. In particular, the source separation layer may be part of the encapsulation. The source separation layer may divide the encapsulation into a first partial encapsulation and a second partial encapsulation. Preferably, the at least one first light source may be arranged (only) in the first partial encapsulation and the at least one second light source may be arranged (only) in the second partial encapsulation. In the case of a plurality of first light sources, all of these light sources may be arranged (only) in the first partial encapsulation. In the case of a plurality of second light sources, all of these light sources may be arranged (only) in the first partial encapsulation.

The source separation layer (preferably also formed of metal, such as a metal sheet) can in particular be arranged in such a way that, in the light source device, no light from the first (respectively the second) light source can pass from the first partial encapsulation (respectively the second partial encapsulation) into the second partial encapsulation (respectively the first partial encapsulation).

Furthermore, a partial encapsulation of the first light source respectively second light source has the effect that scattered light can be prevented from entering the respective other barrier body by exceeding the critical respectively limiting angle. In particular, an optical focusing orthogonal to the surface of the light coupling surface can be provided by a respective partial encapsulation.

Optionally, the at least one light source device may comprise at least one focusing module respectively bundling module arranged downstream of the at least one light source. For example, a lens can be arranged downstream of the at least one light source as a focusing module. This allows the generated light to be coupled into a barrier body in an even more focused manner.

This allows the light coupled into a barrier body to be reflected at the respective boundary surfaces of the barrier body. In particular, the light can be coupled in such a focused manner that the light is reflected at the boundary surfaces of the barrier body and cannot diffuse into an adjacent medium (such as the environment, in particular air, or the other barrier body). In one embodiment, the coupled-in light can emerge only at the surface respectively edge opposite the light-coupling surface.

Preferably, it can be achieved by the focusing by the encapsulation and the source separation layer (optionally by the at least one bundling module) that the angle of incidence φ_{E} of the light propagating in a barrier body at the (optical) separation layer is (always) larger than the total reflection critical angle φ_{G} at this separation layer. In particular, the following relationship (a) applies to the total reflection critical angle φ_{G}:

φ_{G}=arcsin(n_{TS}/n_{SK}), (a)

wherein n_{TS} is the separation layer refractive index and n_{SK} is the (first or second) barrier body refractive index. Here, as described, n_{SK}>n_{TS}. In a particularly preferred embodiment with a barrier body made of acrylic glass or polycarbonate and a polymeric separation layer or an air separation layer, the following values in particular result:
n_{SK}≈1.5 . . . 1.58 (acrylic glass, polycarbonate)
n_{TS}≈1.45 (polymer film)
n_{TS}≈1 (air)
φ_{G}≈65° to 75° (polymer film)
φ_{G}≈40° (air separation layer respectively air gap).

Since in practice the barrier body arrangement is surrounded by air, the total internal reflection critical angle φ_{G} at these boundary surfaces is also φ_{G}≈40°.

According to a further embodiment of the barrier body arrangement according to the application, the at least one light source of the light source device can be controllable. Preferably, all light sources of the light source device may be controllable. In particular, this means that a light source can at least be activated and deactivated depending on a control signal based on and/or containing a command data set. For example, the brightness of a light source can additionally be controllable.

In particular, a controllability allows that only the at least one first light source can be activated while the at least one second light source is deactivated, or only the at least one second light source can be activated while the at least one first light source is deactivated, or the first and second light sources are deactivated or activated.

According to a further preferred embodiment of the barrier body arrangement according to the application, the light source device may comprise at least one third light source arranged (directly) adjacent to the at least one first light source. Adjacent means in particular that the at least one first light source and the at least one third light source are arranged in a common first partial encapsulation. Preferably, a plurality of first light sources and a plurality of third light sources are arranged. Due to the described first partial encapsulation, the light generated by the at least one first light source and the light generated by the at least one third light source are coupled into the first barrier body only via the first light coupling surface.

Preferably, the at least one third light source can be configured to generate light in a third light wavelength range that differs in particular from the first light wavelength range. This makes it possible to illuminate the first barrier body with two different colors (e.g., red and green). In particular, the first and third light sources may be controllable such that either only the at least one first light source is activated (while the at least one third light source is deactivated) or only the at least one third light source is activated (while the at least one first light source is deactivated).

According to a further preferred embodiment of the barrier body arrangement according to the application, the light source device may comprise at least one fourth light source arranged (directly) adjacent to the at least one second light source. Adjacent means in particular that the at least one second light source and the at least one fourth light source are arranged in a common second partial encapsulation. Preferably, a plurality of second light sources and a plurality of fourth light sources are arranged. Due to the described second partial encapsulation, the light generated by the at least one second light source and the light generated by the at least one fourth light source are coupled into the second barrier body only via the second light coupling surface.

Preferably, the at least one fourth light source can be configured to generate light in a fourth light wavelength range that differs in particular from the second light wavelength range. This makes it possible to illuminate the second barrier body with two different colors (e.g., red and green). In particular, the second and fourth light sources may be controllable such that either only the at least one second light source is activated (while the at least one fourth light source is deactivated) or only the at least one fourth light source is activated (while the at least one second light source is deactivated).

This makes it possible to illuminate each of the at least two barrier bodies in at least two different colors. In particular, the light sources can be controlled depending on the current operating state of the passage barrier. If the passage barrier is, for example, in a failure or non-use state due to a defect, for example of the actuator for moving the barrier body arrangement, the light sources can be controlled in such a way that both barrier bodies illuminate red, for example.

Alternatively or additionally, the passage barrier can be operated in different passage directions or set to different passage states. Depending on the set passage state, the first barrier body can be illuminated in a first color and the second barrier body can be illuminated in a different color. For example, the first barrier body may form the front side of the barrier body arrangement and the second barrier body may form the rear side of the barrier body arrangement.

According to a further particularly preferred embodiment of the barrier body arrangement according to the application, at least one of the barrier bodies (preferably all barrier bodies of the barrier body arrangement) can have at least one light decoupling surface respectively diffusion surface. A light decoupling surface is characterized in that the light impinging in the region of the light decoupling surface is decoupled from the barrier body, i.e., the light propagating in the barrier body is not reflected at the light decoupling surface but transmitted therethrough. In other words, (substantially only) at the at least one light decoupling surface of a barrier body a reflection of the light propagating in the barrier body is in particular prevented.

A light decoupling surface means in particular a surface area on an outer side of a barrier body that enables absorption of the light in this surface area of the barrier body. At this at least one surface area, the light propagating in the barrier body can be absorbed and, in particular, diffusely emitted into the environment. The at least one surface area can be perceived by a user in particular as being luminous in color (e.g., green or red, as was described previously).

In order produce a light decoupling surface, the surface can in particular be processed in such a way that the total reflection angle φ_{G,LA} in the area of the light decoupling surface is changed, in particular increased, in such a way that the angle of incidence φ_{E} of the incident light in the area of the light decoupling surface is smaller than the total reflection angle φ_{G,LA}.

In principle, there are various ways to form a light decoupling surface on an outer surface of a barrier body respectively to process the surface of a barrier body in such a way. According to a preferred embodiment of the barrier body arrangement according to the application, the surface of the light decoupling surface may be rougher than the surface of the surrounding surface of the light decoupling surface. In particular, it has been recognized that in a particularly simple manner an absorption of light in a produced surface area of the barrier body can be produced by roughening the corresponding surface area.

In particular, a first surface area is rougher than another (neighboring) surface area if the average roughness Ra of the first surface area is greater than the average roughness Ra of the other (neighboring) surface area. Preferably, the average roughness Ra_{LA} of the surface of the at least one light decoupling surface may be greater than the average roughness Rau of the surface of the surrounding of the light decoupling surface. A roughness measurement can be performed, for example, in accordance with the DIN EN ISO 25178 standard.

Preferably, a production of the at least one light decoupling surface on a barrier body can be carried out by sandblasting. In particular, only the surface area that is to serve as a light decoupling surface can be sandblasted. In a simple manner, a light decoupling surface can be provided. It shall be understood that in variants of the application, the roughening can also be produced by another method.

According to a further embodiment of the barrier body arrangement according to the application, the at least one barrier body may have a light decoupling surface with a specific shape. In particular, the light decoupling surface may be formed in the shape of a specific symbol (e.g., circle, rectangle, arrow, letter, number, etc.). Hereby, a colored luminous symbol can be generated in a simple manner at a barrier body arrangement.

In principle, a barrier body can have any shape. According to a preferred embodiment of the barrier body arrangement according to the application, the at least one barrier body can be a plate-shaped respectively disk-shaped barrier body. A plate-shaped barrier body respectively barrier body plate comprises two flat sides and at least one narrow side. For example, a substantially rectangular barrier body plate has four narrow sides, while a circular or oval-shaped barrier body plate has one circumferential narrow side.

In a preferred embodiment, the first barrier body may have a substantially identical shape to the second barrier body. In particular, the dimensions (e.g., thickness, width, length, diameter, outline shape, etc.) may be substantially the same for the barrier bodies forming the barrier body composite.

According to a further embodiment of the barrier body arrangement according to the application, the at least one light source device may be arranged on a narrow side of the first barrier body and/or the second barrier body. Preferably, the light source device may be arranged on a narrow side of the first barrier body and on a narrow side of the second barrier body. Preferably, said narrow side of the first barrier body and said narrow side of the second barrier body may be arranged immediately adjacent to each other (in the barrier body composite). In the case of a substantially rectangular barrier body, the light source device may extend along the entire length of one of the narrow sides.

Preferably, the substantially optical transparent separation layer may be arranged between a first flat side of the first barrier body and a second flat side of the second barrier body. In particular, the first plate-shaped barrier body can be arranged on the second plate-shaped barrier body, i.e. in particular stacked one on top of the other. In this stacked arrangement, the first barrier body may form the front side and the second barrier body may form the rear side during an intended operation of the passage barrier device.

According to a further embodiment of the barrier body arrangement according to the application, the substantially optically transparent separation layer may be arranged between a first narrow side of the first barrier body and a second narrow side of the second barrier body. In particular, the first plate-shaped barrier body may be arranged adjacent to the second plate-shaped barrier body.

In a further embodiment, two stack arrangements respectively corresponding barrier body arrangements can also be arranged next to each other. In this embodiment, four barrier bodies can be present, two on top of each other and two next to each other.

According to a further embodiment of the barrier body arrangement according to the application, at least one further substantially optically transparent separation layer may be arranged between a further first narrow side of the first barrier body and a further second narrow side of the second barrier body.

In particular, the first barrier body can have a recess (in a narrow side). The shape (in particular the outline) of the second barrier body can preferably correspond to the shape (in particular the outline) of the recess. In particular, the second barrier body may be inserted into the recess for forming the barrier body composite. Between the respective narrow sides of the first barrier body and the second barrier body, the at least substantially optical separation layers may be arranged. The present arrangement may also be referred to as an interleaved arrangement respectively interleaved barrier body composite.

A further aspect of the application is a passage barrier for an access control system. The passage barrier comprises at least one base. The passage barrier comprises at least one barrier body arrangement movably mounted to the base between an open position and a closed position, as previously described.

The base may in particular be formed by at least one base body (e.g. formed in a column-like manner). At least one previously described barrier body arrangement may be attached to the base. The passage barrier may comprise at least one (controllable) actuator (e.g. an electric motor) configured to move the barrier body arrangement between the open position and the closed position of the passage barrier. In the open position, the passage through the passage barrier is unblocked. In the closed position, the passage through the barrier body arrangement of the passage barrier is (physically) blocked.

The passage barrier may in particular be arranged at an entrance and/or exit of a controlled area. The controlled area may, in particular, require a user's access authorization and/or stay authorization for access respectively stay. In particular, the passage barrier according to the application may be used in a public transport (public transit) access control system, but also in other access applications.

In order to verify an authorization of a user for passing the passage barrier, the passage barrier may comprise, according to an embodiment of the passage barrier according to the application, at least one interface equipment. The interface equipment may be configured to receive an access authorization of a user. The passage barrier may comprise at least one release equipment. The release equipment may be configured to release the passage barrier based on a check of the received access authorization, in particular based on the check result of the received access authorization.

The access authorization can preferably be stored in a readable form on a mobile access medium, in particular a ticket medium. The access medium is preferably a mobile terminal, for example with a display respectively a screen. A ticket code can be shown on the display, which can contain at least the access authorization as data content. This can be controlled by an application installed on the mobile terminal.

Exemplary and non-exhaustive mobile devices include smartphones, tablet computers, mobile gaming consoles, laptops, netbooks, smartwatches, and similar wearables. Alternatively, a mobile terminal may be a dedicated access device designed exclusively for an access application.

However, the access medium is not limited to a mobile terminal, but can also be another access medium, such as a paper-based or card-based access medium, for example with a graphic ticket code located on an outer surface, in particular printed on it, or with a magnetic strip.

Furthermore, an access authorization can also be transmitted via near-field technology (e.g. Bluetooth, RFID (Radio-Frequency Identification), NFC (Near Field Communication), WLAN (Wireless Local Area Network) etc.).

The at least one interface equipment may be a Bluetooth interface equipment, RFID interface equipment, NFC interface equipment, WLAN interface equipment, barcode scanner, magnetic stripe scanner, etc. It shall be understood that two or more different interface equipment may be provided. The interface equipment can be integrated in the base or formed by an additional device, which is in particular associated with the passage barrier.

As has already been described, an access authorization can be evaluated by an evaluation module (in a conventional manner). The evaluation module can be integrated in the passage barrier or in a backend system of the access control system. In particular, a comparison of the received access authorization with stored permissible access authorizations or non-permissible access authorizations can be carried out.

If the evaluation results in that the user is authorized for passing through the passage barrier, the evaluation module can generate a release signal and can in particular transmit it to the release equipment. When the release signal is received, the release equipment can control the actuator of the passage barrier with a corresponding control signal. A movement of the barrier body arrangement into the open position can be caused so that the user can pass the passage barrier. If the evaluation results in that the user is not authorized for passing the passage barrier, the passage barrier can remain blocked.

Preferably, the access control system may comprise at least one passage barrier and at least one backend system (e.g. formed by at least one server) communicatively coupled to the passage barrier. For example, the evaluation module may be integrated in the backend system located remotely from the passage barrier. Further, the access control system may comprise an access medium described previously.

According to a preferred embodiment of the passage barrier according to the application, the passage barrier may comprise at least one detection module. The detection module may be configured to detect an (current) operating state of the passage barrier. The passage barrier may comprise at least one light source controller. The light source controller may be configured to control the light source device based on the detected operating state of the passage barrier.

As has already described, a passage barrier can adopt various (predefined) operating states respectively be set to these states by a corresponding state control signal. The detection module can in particular detect the current operating state, for example by the detection module being configured to receive and evaluate the state control signal.

Exemplary and non-exhaustive examples of pre-definable operating states are a first passage direction state (passage only possible in a first direction and blocked in the opposite direction), a second passage direction state (passage only possible in the opposite direction and blocked in the first direction), a third passage direction state (passage possible in both directions), a blocking state, a validation state (release of the passage block, for example, due to a positive check of a user's access authorization), a failure state and a maintenance state.

In particular, the validation state may also be combined with one of the three passage direction states, i.e. the passage barrier is operated to release, for example, due to a positive check of an access authorization of a user, wherein the user is offered the check of the access authorization exclusively in the first passage direction (and not to another user in the opposite direction), or wherein the user is offered the check of the access authorization in the opposite direction only (and not to another user in the first through direction), or wherein two users are offered the check of their respective access authorization in both passage directions, and wherein the passage barrier opens for the user whose access authorization was first positively checked in the corresponding passage direction.

The detection module can be integrated in the light source controller. The light source controller is configured to control the controllable light sources of the light source device. Preferably, an assignment table (or the like) may be stored in the light source controller. In the assignment table, a command data set may be assigned (in a unique manner) to each operating state of the passage barrier. The command data set can at least define which of the light sources are activated and which are deactivated by the light source controller. Optionally, a brightness to be set or the like can also be predefined.

In a further embodiment, the assignment table (or the like) may be stored in a data memory external to the passage barrier such that the light source controller can access the stored command data sets over a data network. In this embodiment, the assignment table may be stored, for example, on a computer unit for controlling a passage barrier array (respectively gate array) having a plurality of passage barriers, or on a computer unit for controlling a plurality of passage barrier arrays at a station, or on a remotely located central computer unit, such as a backend system and/or cloud computer system.

Based on the detected operating state, the light source controller can determine the command data set and, in particular, control the light source device with the command data set. Preferably, the at least two barrier bodies of the barrier body arrangement of the passage barrier can be illuminated in different colors depending on the operating state of the passage barrier.

A still further aspect is a method of operating a previously described passage barrier. The method comprises:
controlling, by a light source control, the light source device of the barrier body arrangement based on an operating state of the passage barrier.

In particular, the light source controller may control the light source device in the manner described above. The method may comprise detecting, by a detection module, an operating state of the passage barrier.

A previously described module, device, equipment, etc., may include at least partial hardware elements (e.g., processor, memory means, etc.) and/or at least partial software elements (e.g., executable code). It should also be noted that terms such as “first”; “second”, “further”, etc. do not indicate an order, but are used in particular to distinguish between two elements (e.g., barrier body, light source, area, etc.).

The features of the barrier body arrangements, passage barriers, methods and access control systems can be freely combined with each other. In particular, features of the description and/or of the dependent claims may be independently inventive, even by completely or partially circumventing features of the independent claims, in sole position or freely combined with each other.

### BRIEF DESCRIPTION OF THE DRAWINGS

There are now a multitude of possibilities for designing and further developing the barrier body arrangement according to the application, the passage barriers according to the application, the access control system according to the application and the method according to the application. For this purpose, reference is made on the one hand to the patent claims subordinate to the independent patent claims, and on the other hand to the description of embodiments in connection with the drawings. The drawings show:

FIG. 1a a first schematic view of an embodiment of a barrier body arrangement according to the present application,

FIG. 1b a further schematic view of the embodiment of the barrier body arrangement according to FIG. 1a,

FIG. 1c a further schematic view of the embodiment of the barrier body arrangement according to FIG. 1a,

FIG. 1d a further schematic view of the embodiment of the barrier body arrangement according to FIG. 1a,

FIG. 1e a further schematic view of the embodiment of the barrier body arrangement according to FIG. 1a,

FIG. 2 a schematic view of a further embodiment of a barrier body arrangement according to the present application,

FIG. 3 schematic views of a further embodiment of a barrier body arrangement according to the present application,

FIG. 4 a schematic view of a further embodiment of a barrier body arrangement according to the present application,

FIGS. 5a to 5c schematic views of a further embodiment of a barrier body arrangement according to the present application,

FIGS. 6a to 6e schematic views of a further embodiment of a barrier body arrangement according to the present application,

FIGS. 7a to 7e schematic views of a further embodiment of a barrier body arrangement according to the present application,

FIG. 8 a schematic view of a further embodiment of a barrier body arrangement according to the present application,

FIG. 9 a schematic view of an embodiment of an access control system according to the present application with an embodiment of a passage barrier according to the present application, and

FIG. 10 a diagram of an embodiment of a method according to the present application.

In the following, similar reference signs are used for similar elements.

### DETAILED DESCRIPTION OF SPECIFIC EMBODIMENTS

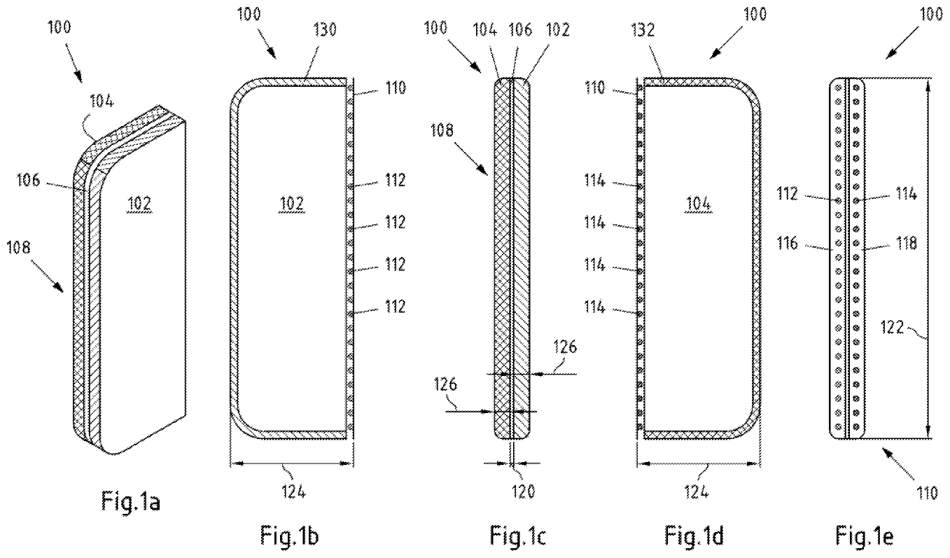

FIGS. 1a to 1e show various schematic views of an embodiment of a barrier body arrangement 100 according to the present application. FIG. 1a shows a perspective view, FIG. 1b shows a front view, FIG. 1c shows a side view, FIG. 1d shows a rear view, and FIG. 1e shows a further side view of the barrier body arrangement 100.

The barrier body arrangement 100 serves for use as a physical barrier element in a passage barrier of an access control system. In the present case, the barrier body arrangement comprises two transparent barrier bodies 102, 104 and a transparent (optical) separation layer 106, which is arranged between the barrier bodies 102, 104. In particular, the barrier bodies 102, 104 and the separation layer 106 form a barrier body composite 108. In particular, the barrier bodies 102, 104 and the separation layer 106 are firmly respectively permanently connected to one another and thus form the barrier body composite 108.

Preferably, a barrier body 102, 104 may be formed of acrylic and/or polymer carbonate. In particular, the separation layer 106 may be a polymeric separation film 106. In particular, the separation film 106 may be coated on both sides with an optically transparent adhesive. In a simple manner, the barrier bodies 102, 104 may be joined together by the separation film 106 in order to form the barrier body composite 108.

As can be seen from the Figures, the first barrier body 102 and the second barrier body 104 are formed in a plate-shaped and disk-shaped manner, respectively. In particular, the two barrier bodies 102, 104 may be formed identically. The outline of the barrier bodies 102, 104 may be substantially rectangular (as shown, corners may be rounded, for example).

In the present case, the separation layer 106 is arranged between two flat sides (which lie inside the barrier body composite 108) of the barrier bodies 102, 104. The outline of the separation layer 106 may substantially correspond to the outline of the barrier bodies 102, 104.

A barrier body 102, 104 may have a length 122 between preferably 30 cm and 120 cm. The width 124 of a barrier body 102, 104 can preferably be between 20 cm and 80 cm. The thickness 126 of a barrier body 102, 104 is in particular between 3 and 20 mm, preferably between 4 and 10 mm. The separation layer 106 may preferably have a thickness 128 of between 0.05 and 10 mm, more preferably between 0.15 and 0.5 mm.

It shall be understood that in variants of the application, the barrier bodies may also have different dimensions, at least in part.

The barrier body arrangement 100 comprises a light source device 110, exemplified herein by two light source strips 110. In the shown preferred embodiment, the light source device 110 comprises a plurality of first light sources 112, in particular in the form of LEDs 112, and a plurality of second light sources 114, in particular in the form of LEDs 114.

The light source device 110 is configured to couple light into the first light coupling surface 116 of the first barrier body 102 and/or the second light coupling surface 118 of the second barrier body 104. In particular, the plurality of first light sources 112 are configured to couple light into the first light coupling surface 116 and the plurality of second light sources 114 are configured to couple light into the second light coupling surface 118.

The first light sources 112 may be configured to generate light in a first light wavelength range (e.g., 500 nm to 570 nm). The second light sources 114 may be configured to generate light in a second light wavelength range (e.g., 610 nm to 760 nm) that is in particular different from the first light wavelength range.

Preferably, the light source device 110 is arranged on a narrow side respectively an edge of the first and, in particular, also of the second barrier body 102, 104. In particular, this respective narrow side substantially forms the respective light coupling surface 116, 118. As shown, the light source device 110 may extend along the entire length 122 of the respective narrow side.

According to the application, a separation layer refractive index n_{TS} of the separation layer 106 is at least smaller than a first barrier body refractive index n_{SK1} of the first barrier body 102 and a second barrier body refractive index n_{SK2} of the second barrier body 104. This achieves that the barrier body composite 108 is optically transparent, but at the same time an optical separation between the first barrier body 102 and the second barrier body 104 is provided by the interface layer 106. Thus, the separation layer 106 according to the application can prevent light coupled via the first light coupling surface 116 from entering into the second barrier body 104, and light coupled via the second light coupling surface 118 from entering into the first barrier body 102.

As indicated in FIGS. 1a to 1e, the respective coupled light may be visible to users of the passage barrier (only) at the further narrow sides 130, 132 respectively edges 130, 132 of the respective barrier body 102, 104. For example, (only) edge 130 may illuminate green (while the remaining area appears only transparent and not colored) and edge 132 may illuminate red (while the remaining area appears only transparent and not colored). In particular, for a user located in front of the front side (cf. FIG. 1b), only the first (e.g. green) illumination is visible, while for a user located in front of the rear side (cf. FIG. 1d), only the second (e.g. red) illumination is visible.

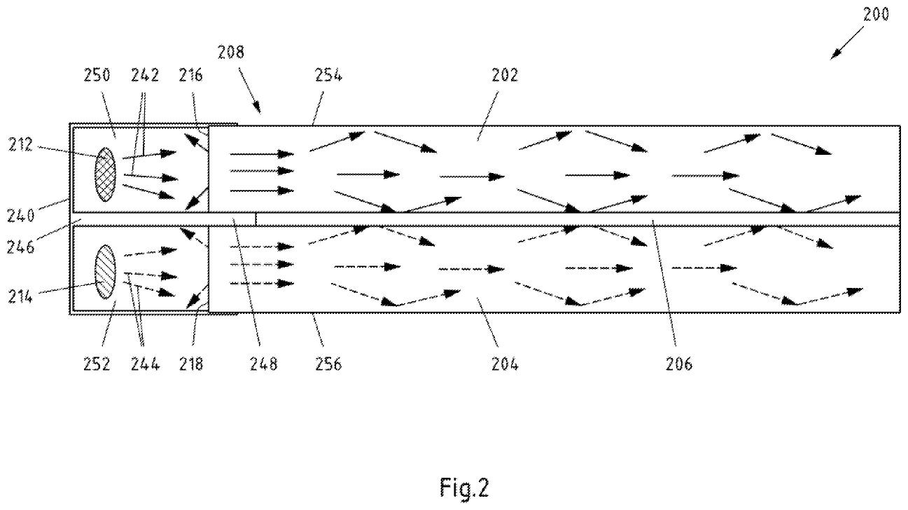

FIG. 2 shows a schematic (sectional) view of a further embodiment of a barrier body arrangement 200 according to the present application. In order to avoid repetitions, essentially only the differences from the embodiment according to FIGS. 1a to 1e are described below and otherwise reference is made to the previous explanations. FIG. 2 serves in particular to explain in further detail the operation of a barrier body arrangement 200 according to the present application.

A light source device 210 having at least one first light source 212 and at least one second light source 214 is arranged on a narrow side of the barrier body composite 208. The illustrated light source device 210 comprises an optically non-transparent encapsulation 240 respectively housing. In other words, light cannot pass through the encapsulation 240. For example, the encapsulation may be made of metal or another opaque material.

The encapsulation 240 is preferably arranged in such a way that the light 242, 244 generated by the light source device 210, in particular the light sources 212, 214 (indicated by the arrows), is coupled only into the first light coupling surface 216 and the second light coupling surface 218. In other words, the at least one light source 212, 214 is in the present case completely surrounded respectively encapsulated by the encapsulation 240 and the barrier bodies 202, 204, i.e. in particular the narrow sides 216, 218 of the barrier bodies 202, 204. As can be seen, the encapsulation 240 has a U-shaped cross-section for this purpose.

Further, an optically non-transparent source separation layer 246 made of an opaque material (e.g., metal) is arranged in the light source device 210 between the at least one first light source 212 and the at least one second light source 214. The source separation layer 246 extends from an inner wall of the encapsulation 240 to at least the first barrier body 202 and second barrier body 204, respectively. Preferably, one end of the source separation layer 246 may extend into an intermediate space 248 between the first barrier body 202 and the second barrier body 204. This end of the source separation layer 246 may preferably be immediately followed by the optically transparent separation layer 206.

In particular, the source separation layer 246 may be part of the encapsulation 240 and preferably made of the same material. A first partial encapsulation 250 and a second partial encapsulation 252 are provided by the source separation layer 240 in the present embodiment.

The at least one first light source 212 is arranged in particular (only) in the first partial encapsulation 250 and the at least one second light source 214 is arranged (only) in the second partial encapsulation 252. A partial encapsulation 250, 252 of the first light source 212 and second light source 214, respectively, has the particular effect that scattered light and total reflection by critical angle exceeding can be prevented to propagate into the respective other barrier body 202, 204.

In particular, optical focusing orthogonal to the surface of the light input surface 216, 218 may be provided by a respective partial encapsulation 250, 252. Optionally, the light source device may comprise, in particular, not shown focusing modules (e.g., lenses) in front of each light source to further focus the generated light.

As further indicated in FIG. 2 by the arrows (different arrows shall symbolize in particular light of different wavelengths), the respectively coupled light propagates (in particular due to the described focusing) essentially orthogonally to the light coupling surface 216, 218.

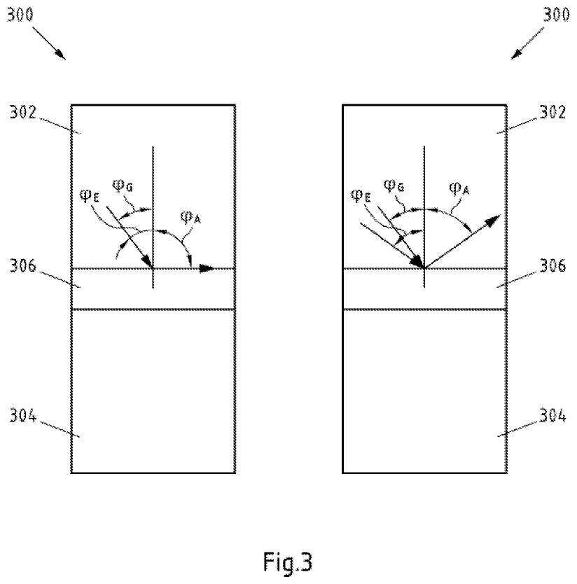

Due to the separation layer 206 according to the application, this light is reflected by the separation layer. Since the barrier body arrangement 200 is generally surrounded by air and the refractive index of the air is less than the first barrier body refractive index of the first barrier body 202 and the second barrier body refractive index of the second barrier body 204, light also does not emerge from the outer flat surfaces 254, 256 of the barrier body arrangement 208 and the respective barrier body 202, 204, respectively. The light is also reflected at these boundary surfaces 254, 256. This will be explained in more detail below with the aid of FIG. 3.

Presently, the light may emerge from the narrow edges opposite the light coupling surfaces 216, 218.

FIG. 3 shows schematic views of an extract of a barrier body arrangement 300 according to the present application with different angles of incidence of light.

On the left side of FIG. 3 a (border) case (incidence of light at the critical angle) is shown where the angle of incidence φ_{E} of the light is equal to the critical angle φ_{G}. As can be seen, this results in the angle of reflection being φ_{A}=90°. On the right side of FIG. 3, the (normal) case (total internal reflection) is shown, where the angle of incidence φ_{E} of the light is larger than the critical angle φ_{G}. In this case, the light is reflected. In particular, the angle of reflection φ_{A} is equal to the angle of incidence φ_{E}. As has already been described, the light source device (in particular the encapsulation with the source separation layer) can focus the coupled light in such a way that the angle of incidence φ_{E} of the light at the separation layer 306 is (always) larger than the critical angle φ_{G}.

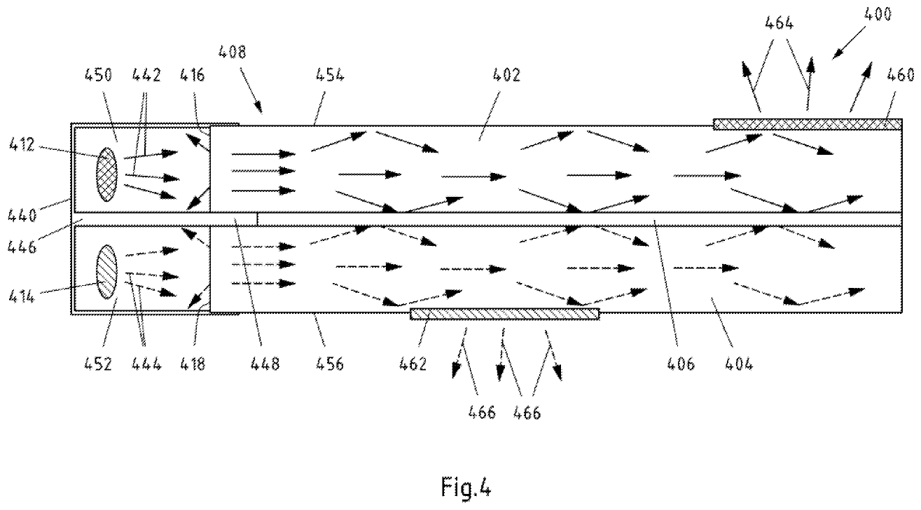

FIG. 4 shows a schematic view of a further embodiment of a barrier body arrangement 400 according to the present application. In order to avoid repetitions, the differences from the previous embodiments (in particular in comparison with the embodiment according to FIG. 2) are essentially described below and otherwise reference is made to the previous explanations.

The shown barrier body arrangement 400 comprises at least one light decoupling surface 460, 462 respectively diffusion surface 460, 462. Presently, each barrier body 402, 404 comprises at least one light decoupling surface 460, 462. As indicated in FIG. 4 by the arrows 464, 466, the light impinging on the inside of the light decoupling surface 460, 462 emerges from the barrier body 402, 404 through the light decoupling surface 460, 462, i.e. it is decoupled.

As can be seen, the light emerges from an outer flat side 454, 456 (which extends in particular substantially parallel to the light propagation direction) only at the at least one light decoupling surface 460, 462 of a barrier body 402, 404. Only in this area of the outer surface 454, 456 a reflection of the light propagating in the barrier body 402, 404 is prevented. In the remaining area of the outer surface 454, 456, the light continues to be reflected.

At the surface area 460, 462, the light propagating in the barrier body 402, 404 is absorbed and, in particular, diffusely emitted into the environment. The light decoupling surface 460, 462 may preferably be luminous in color and therefore perceived by a user as being luminous in color (e.g., green or red, as has been described previously).

In the present embodiment, the surface of the light decoupling surface 460, 462 may be rougher than the surface of the surrounding surface of the light decoupling surface 460, 462. Preferably, the average roughness Ra_{LA} of the surface of the at least one light decoupling surface 460, 462 may be greater than the average roughness Rau of the surface of the surrounding surface of the light decoupling surface 460, 462. A production of the at least one light decoupling surface 460, 462 may be performed by sandblasting.

In particular, the light decoupling surface 460, 462 may be formed in the shape of a specific symbol (e.g., circle, rectangle, arrow, letter, number, etc.) by sandblasting (or the like).

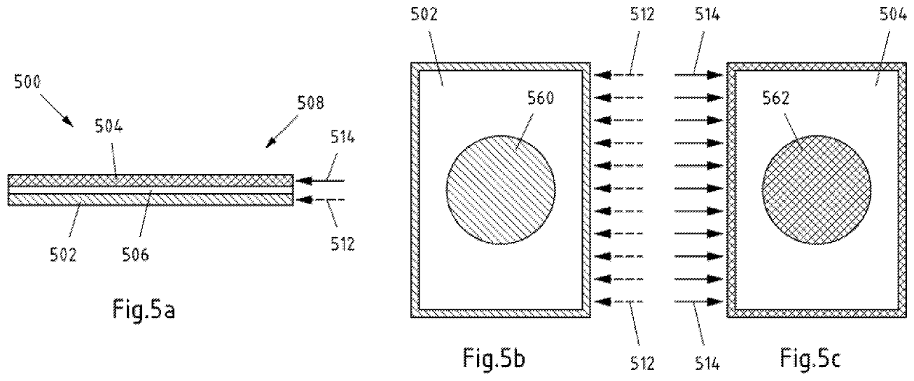

FIGS. 5a to 5c show various views of a further embodiment of a barrier body arrangement 500 according to the present application. FIG. 5a shows a top view, FIG. 5b shows a front view and FIG. 5c shows a rear view of the barrier body arrangement 500. In order to avoid repetitions, essentially the differences from the previous embodiments are described below and otherwise reference is made to the previous explanations. For the sake of clarity, a light source device is not explicitly shown in these figures, but only the respective at least one light source is shown by arrows.

In particular, a barrier body composite 508 is shown in these Figures in the form of a stacked arrangement. In the present case, the optically transparent separation layer 506 is arranged between a first flat side of the first barrier body 502 and a second flat side of the second barrier body 504. In this stacked arrangement, the first barrier body 502 can form the front side (cf. FIG. 5b) and the second barrier body 504 can form the rear side (cf. FIG. 5c) in the intended operation of the passage barrier. Each barrier body 502, 504 comprises a light decoupling surface 560, 562 exemplarily in the form of a circle.

Preferably, the first light sources 512 can generate light with a different wavelength than the second light sources 514 (indicated by the different arrows and hatching). This allows that the front side and the rear side can be illuminated in different colors at the same time. In this case, essentially only the respective light decoupling surface 560, 562 is illuminated, while the remaining area appears colorless and transparent to a user.

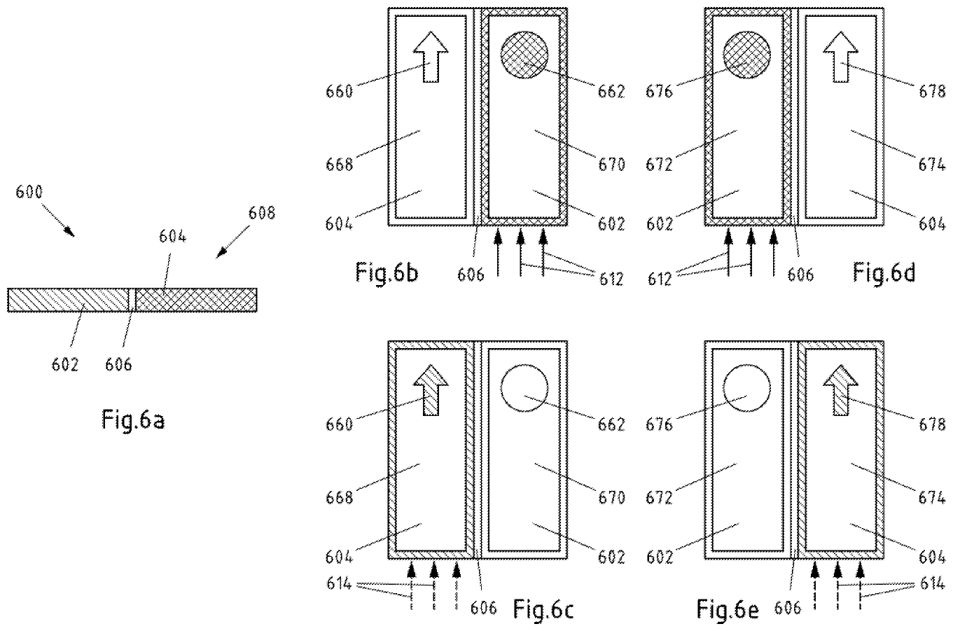

FIGS. 6a to 6e show various views of a further embodiment of a barrier body arrangement 600 according to the present application. FIG. 6a shows a top view, FIG. 6b shows a front view of the barrier body arrangement 600 in a first illumination state, FIG. 6c shows a front view of the barrier body arrangement 600 in a second illumination state, FIG. 6d shows a rear view of the barrier body arrangement 600 in the first illumination state, and FIG. 6e shows a rear view of the barrier body arrangement 600 in the second illumination state. In order to avoid repetitions, essentially the differences to the previous embodiments are described below, and otherwise reference is made to the previous embodiments. For the sake of clarity, a light source device is not explicitly shown in these Figures, but only the respective at least one light source is shown by arrows.

As can be seen, the first optically transparent barrier body 602 is presently arranged adjacent to the second optically transparent barrier body 604. In this barrier body composite 608, the optically transparent separation layer 606 is arranged between two narrow sides of the plate-shaped barrier bodies 602, 604.

From the front view (cf. FIGS. 6b and 6c), it can be seen that the front side of the barrier body arrangement 600 is formed by the front flat sides 668, 670 of the two barrier bodies 602, 604. The rear side (cf. FIGS. 6d and 6e) of the barrier body arrangement 600 is formed by the two rear flat sides 672, 674 of the two barrier bodies 602, 604. Each flat side 668 to 674 has at least one light decoupling surface 660, 662, 676, 678. Exemplarily, two light decoupling surfaces 660, 678 are presently shaped as an arrow, while the other two are shaped as a circle.

Preferably, the first light sources 612 can generate light with a different wavelength than the second light sources 614 (indicated by the different arrows and hatchings). As a result, in the first illumination state (cf. FIGS. 6b and 6d), when in particular only the first light sources 612 are activated while the second light sources 614 are deactivated, the light decoupling surfaces 662 and 676 illuminate in a first color (e.g., red). In this illumination state, in particular, the other two light decoupling surfaces 660, 678 of the second barrier body 604 are not illuminated. The second barrier body appears completely colorless and transparent.

This can, for example, indicate a failure state of the passage barrier and, in particular, signal to a user that it is not (currently) possible to pass through the passage barrier. It can also signal to the user that the passage barrier is (still) in a blocking state because, for example, a check of an access authorization of the user is not (yet) positive.

In particular, in the second illumination state (cf. FIGS. 6c and 6e), only the second light sources 614 may be activated, while the first light sources 612 are deactivated. In this illumination state, the light decoupling surfaces 660 and 678 may be illuminated in a different color (e.g., green) than the first color. This may indicate, for example, a fault-free operating state of the passage barrier and, in particular, indicate to a user that passage of the passage barrier is (currently) possible. In addition, the passage barrier may be in a bidirectional passage state. It can also signal to the user that a check of his access authorization was positive and in particular that the passage barrier is now released.

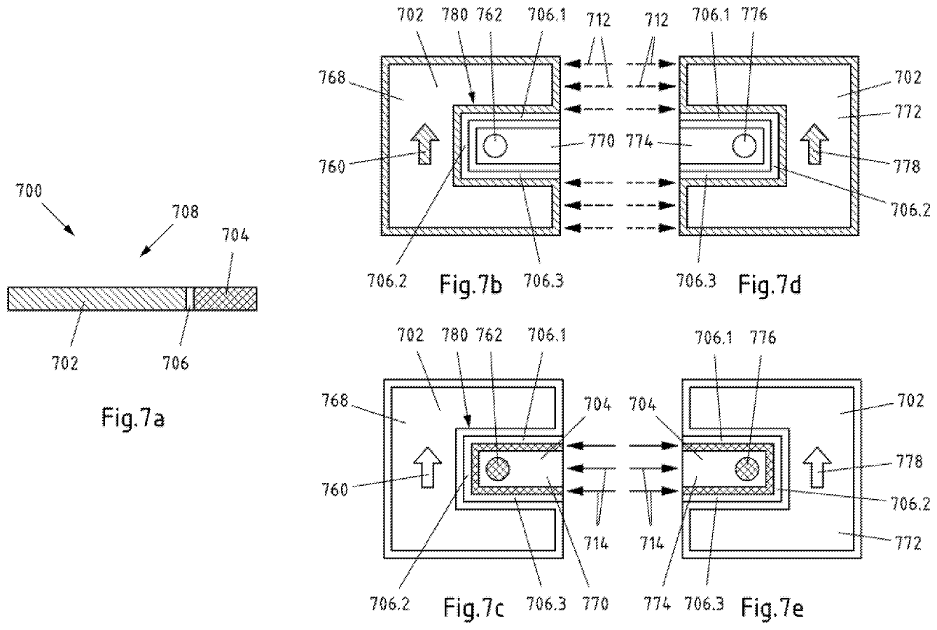

FIGS. 7a to 7e show various views of a further embodiment of a barrier body arrangement 700 according to the present application. FIG. 7a shows a top sectional view, FIG. 7b shows a front view of the barrier body arrangement 700 in a first illumination state, FIG. 7c shows a front view of the barrier body arrangement 700 in a second illumination state, FIG. 7d shows a rear view of the barrier body arrangement 600 in the first illumination state, and FIG. 7e shows a rear view of the barrier body arrangement 700 in the second illumination state. In order to avoid repetitions, essentially the differences to the previous embodiments are described below and otherwise reference is made to the previous embodiments. For the sake of clarity, a light source device is not explicitly shown in these Figures, but only the respective at least one light source is shown by arrows.

In particular, FIGS. 7a to 7e illustrate an interleaved barrier body arrangement 700. In the present embodiment, three separation layers 706.1 to 706.3 respectively separation layer regions 706.1 to 706.3 (wherein the separation layer regions 706.1 to 706.3 may be formed integrally) are arranged between narrow sides of the first barrier body 702 and the second barrier body 704, as an example. In particular, a recess 780 is provided in the first barrier body 704. The outline of the second barrier body 704 corresponds to the recess of the first barrier body 702. In particular, the second barrier body 704 can be inserted into the recess of the first barrier body 702 to form the barrier body composite 708.

From the front view (cf. FIGS. 7b and 7c), it can be seen that the front side of the barrier body arrangement 700 is formed by the two front flat sides 768, 770 of the two barrier bodies 702, 704. The rear side (cf. FIGS. 7d and 7e) of the barrier body arrangement 700 is formed by the two rear flat sides 772, 774 of the two barrier bodies 702, 704. Each flat side 768 to 774 has at least one light decoupling surface 760, 762, 776, 778. Exemplarily, in the present case, two light decoupling surfaces 760, 778 are shaped as an arrow, while the other two are shaped as a circle.

Preferably, the first light sources 712 can generate light with a different wavelength than the second light sources 714 (indicated by the different arrows and hatchings). As a result, in the first illumination state, when in particular only the first light sources 712 are activated while the second light sources 714 are deactivated, the light decoupling surfaces 760 and 778 illuminate in a first color (e.g., green). In this state, in particular, the other two light decoupling surfaces 760, 778 of the second barrier body 704 are not illuminated. The second barrier body 704 appears completely colorless and transparent.

This can, for example, indicate a fault-free operating state of the passage barrier and, in particular, signal to a user that it is (currently) possible to pass through the passage barrier. In addition, the passage barrier may be in a bidirectional passage state. It can also signal to the user that a check of his access authorization was positive and, in particular, that the passage barrier is released.

In particular, in the second illumination state, only the second light sources 714 may be activated, while the first light sources 712 are deactivated. In this illumination state, the light decoupling surfaces 762 and 776 may illuminate in a different color (e.g., red) than the first color. This may, for example, indicate a failure state of the passage barrier and, in particular, signal to a user that passage of the passage barrier is (currently) not possible. It can also signal to the user that the passage barrier is (still) in a blocking state, for example because a check of an access authorization of the user is not (yet) positive.

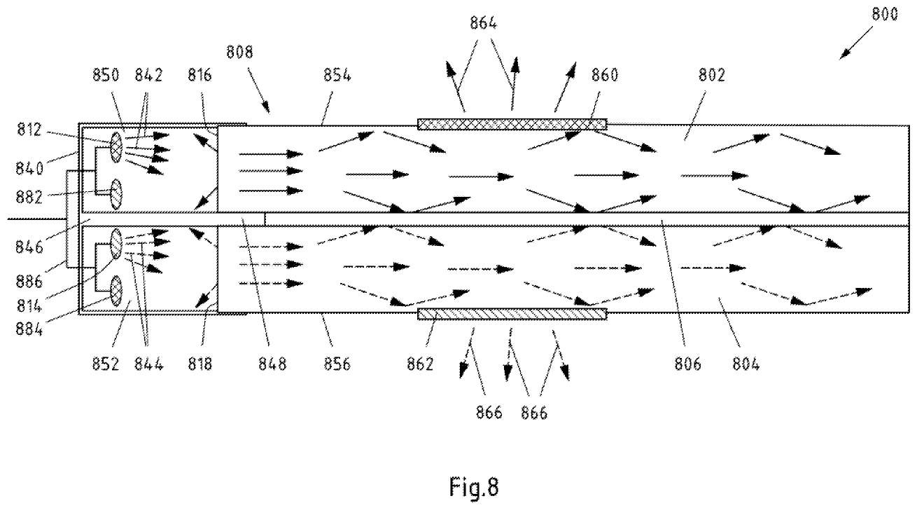

FIG. 8 shows a schematic view of a further embodiment of a barrier body arrangement 800 according to the present application. In order to avoid repetitions, the differences to the previous embodiments (in particular in comparison to the embodiment according to FIG. 4) are essentially described below and otherwise reference is made to the previous explanations.

In addition to the at least one first light source 812 and the at least one second light source 814, the light source device 810 comprises at least one third light source 882 and at least one fourth light source 884. The at least one first light source 812 and the at least one third light source 882 are in particular integrated in a first partial encapsulation 850. The at least one second light source 814 and the at least one fourth light source 884 are in particular integrated in a second partial encapsulation 852.

By means of a communication connection 886, the light sources 812, 814, 882, 884 can be controlled, in particular activated and deactivated. Optionally, the brightness can be changed.

The at least one third light source 882 is presently configured to generate light in a third light wavelength range that differs in particular from the first light wavelength range of the first light source. This makes it possible to illuminate the first barrier body 802 with two different colors (e.g., red and green).

In particular, the first and third light sources 812, 882 may be controllable such that either only the at least one first light source 812 is activated (while the at least one third light source 882 is deactivated) or only the at least one third light source 882 is activated (while the at least one first light source 812 is deactivated).

The at least one fourth light source 884 is presently configured to generate light in a fourth light wavelength range that differs in particular from the second light wavelength range of the second light source 814. This makes it possible to illuminate the second barrier body 804 with two different colors (e.g., red and green). In particular, the second and fourth light sources 814, 884 may be controllable such that either only the at least one second light source 814 is activated (while the at least one fourth light source 884 is deactivated) or only the at least one fourth light source 884 is activated (while the at least one second light source 814 is deactivated).

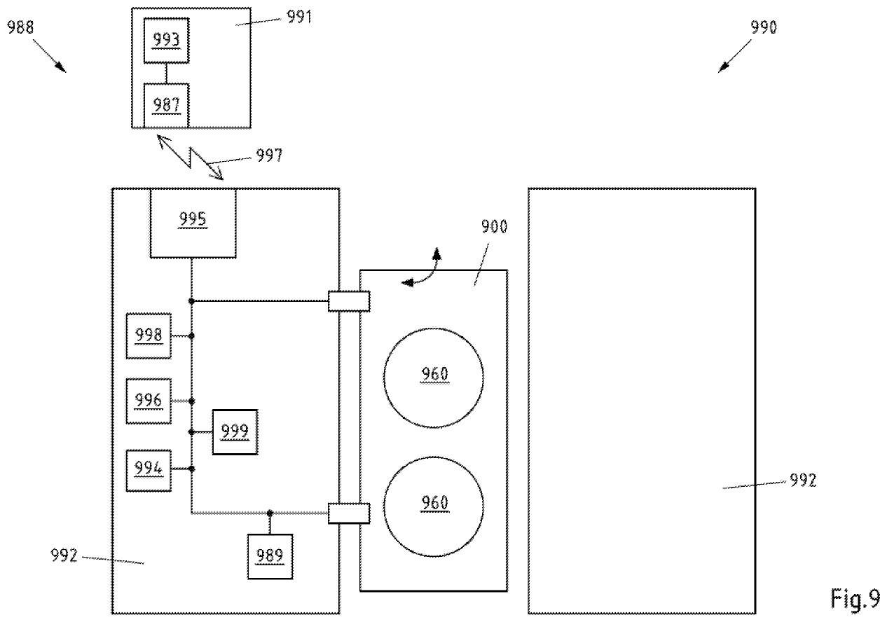

FIG. 9 shows a schematic view of an embodiment of an access control system 988 according to the present application with an embodiment of a passage barrier 990 according to the present application. The passage barrier 990 in the present application comprises a barrier body arrangement 900, which may be formed, for example, in accordance with one of the previously described embodiments. For the sake of a better overview, the details of the barrier body arrangement 900 are not shown in FIG. 9.

In the present embodiment, the access control system 988 comprises a backend system 991 and at least one passage barrier 990. In particular, a plurality of passage barriers 990 may be provided, for example, at least one passage barrier array (also referred to as a gate array) having a plurality of passage barriers.

In addition to the barrier body arrangement 900, the passage barrier 988 comprises a base 992. In the present case, the base 992 is formed by two base bodies 992 respectively stand bodies 992. The barrier body arrangement 900 is movably attached to the base 992. By means of at least one actuator 999 (for example an electric motor 999), the barrier body arrangement 900 can be moved respectively displaced between a closed position (as shown in FIG. 9) and an open position. This is indicated by the arrow.

In particular, the actuator 999 is integrated in the base 992. In the present embodiment, a detection module 994, a light source controller 996, a release equipment 998, a communication module 995, and an interface equipment 989 are further integrated in the base 992. It shall be understood that in other variations of the application, fewer elements may be provided or additional elements may be provided, such as another interface equipment (based on a different transmission technology).

In particular, the communication module 995 is configured to communicate with a communication module 987 of the backend system 991 via a (wireless and/or wired) distance communication network 997.

In particular, the at least one interface equipment 989 (e.g., a barcode scanner, a Bluetooth interface, NFC interface, a magnetic stripe reader, etc.) is configured to receive an access authorization (ticket code, user ID, etc.) of the user from a (pre-described) access medium of the user. In particular, a valid access identifier allows passage through the passage barrier 990.

Upon receipt of an access authorization by the interface equipment 989, the access authorization may be forwarded to the backend system 991 by the communication module 997. An evaluation module 993 of the backend system 991 may check the forwarded access authorization (in a conventional manner), for example, by comparing it to stored permissible access identifiers. In other variants, an evaluation module may also be integrated in the passage barrier.

The check result may be transmitted to the passage barrier 990 by the communication module 987. For example, if it is determined that the forwarded access authorization is identical to a stored permissible access identifier and the forwarded access authorization is therefore a valid access authorization, a corresponding positive check result may be transmitted. If, for example, it is determined that the forwarded access authorization is not identical to a stored permissible access identifier and the forwarded access authorization is therefore an invalid access authorization, a corresponding negative check result can be transmitted.

The check result may be provided to the release equipment 998. For example, a release signal may be transmitted when the check result is positive. Based on the check result, the release equipment 998 may control the actuator 999. For example, the actuator 999 may be controlled to cause the barrier body arrangement 900 to move from the closed position to the open position (upon a positive check result).

The detection module 994 may be configured to detect the current operating state of the passage barrier 990, in particular as previously described. Preferably, at least one of a positive check result and a state control signal may be provided to the detection module 994.

The detected operating state may be provided to the light source controller 996. Based on the detected operating state and, in particular, an assignment table described above, the light source controller 996 may control the light sources of the light source device of the barrier body arrangement 900, as described in particular above.

In another embodiment, the light source controller 996 may be configured to illuminate the two barrier bodies of the barrier body arrangement 900 in different colors (for example, red and green) depending on an operating state of the passage barrier device 990, so that a user can recognize whether or not the passage barrier device 900 is usable in the desired direction of passage based on the color of the light decoupling surface 960 as soon as the passage barrier device 900 is approached.

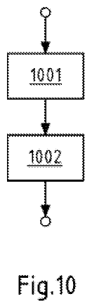

FIG. 10 shows a diagram of an embodiment of a method according to the present application for operating a passage barrier, such as the passage barrier shown in FIG. 9.

In a step 1001, a detecting, by a detection module, of the current operating state of the passage barrier may be performed, as described in particular previously.

In step 1002, controlling, by a light source control, of the light source device of the barrier body arrangement is performed based on an operating state of the passage barrier device, in particular the previously detected operating state of the passage barrier device.

After a specific period of time has elapsed and/or upon detection of a changed operating state, the light source device of the barrier body arrangement can be controlled again by the light source control, based on a predefined control rule and/or the operating state that is now present. In particular, the control rule can also be integrated in an assignment table.

What is claimed is:

1. A barrier body arrangement for a passage barrier of an access control system, comprising:
at least one first substantially optically transparent barrier body having at least one first light coupling surface,
at least one second substantially optically transparent barrier body having at least one second light coupling surface,
wherein the first barrier body is connected to the second barrier body,
at least one light source device configured to couple light into the first light coupling surface and/or the second light coupling surface,
wherein at least one substantially optical transparent separation layer is arranged between the first barrier body and the second barrier body.

2. The barrier body arrangement according to claim 1, wherein
a separation layer refractive index of the separation layer is smaller than a first barrier body refractive index of the first barrier body and than a second barrier body refractive index of the second barrier body.

3. The barrier body arrangement according to claim 2, wherein
the separation layer refractive index is less than 1.5, and/or
the at least one barrier body refractive index is greater than or equal to 1.5.

4. The barrier body arrangement according to claim 1, wherein
the light source device comprises an optically non-transparent encapsulation.

5. The barrier body arrangement according to claim 1, wherein
the light source device comprises at least one first light source configured to generate light in a first light wavelength range, and
the light source device comprises at least one second light source configured to generate light in a second light wavelength range different from the first light wavelength range.

6. The barrier body arrangement according to claim 5, wherein,
the at least one first light source is arranged in the light source device such that the generated light is coupled only into the at least one first light coupling surface, and
the at least one second light source is arranged in the light source device such that the generated light is coupled only into the at least one second light coupling surface.

7. The barrier body arrangement according to claim 1, wherein
at least one of the barrier bodies comprises at least one light decoupling surface.

8. The barrier body arrangement according to claim 7, wherein
the surface of the light decoupling surface is rougher than the surface of the surrounding surface of the light decoupling surface.

9. The barrier body arrangement according to claim 1, wherein
the at least one barrier body is a plate-shaped barrier body.

10. The barrier body arrangement according to claim 9, wherein
the at least one light source device is arranged on a narrow side of the first barrier body and/or of the second barrier body.

11. The barrier body arrangement according to claim 9, wherein
the separation layer is arranged between a first flat side of the first barrier body and a second flat side of the second barrier body.

12. The barrier body arrangement according to claim 9, wherein
the separation layer is arranged between a first narrow side of the first barrier body and a second narrow side of the second barrier body.

13. The barrier body arrangement according to claim 12, wherein
at least one further separation layer is arranged between a further first narrow side of the first barrier body and a further second narrow side of the second barrier body.

14. A passage barrier of an access control system, comprising:
at least one base, and
at least one barrier body arrangement according to claim 1 movably mounted to the base between an open position and a closed position.

15. The passage barrier according to claim 14, wherein
the passage barrier comprises at least one detection module configured to detect an operating state of the passage barrier, and
the passage barrier comprises at least one light source controller configured to control the light source device based on the detected operating state of the passage barrier.

16. A method of operating a passage barrier according to claim 14, comprising:
controlling, by a light source controller, the light source device of the barrier body arrangement based on an operating state of the passage barrier device.

17. The barrier body arrangement according to claim 3, wherein
the separation layer refractive index is between 1 and 1.49, and/or
the at least one barrier body refractive index is between 1.5 and 1.9.
